(19) United States
(12) Patent Application Publication
(10) Pub. No.: US 2009/0323635 A1
(43) Pub. Date: Dec. 31, 2009

(54) METHOD OF MANAGING INTER WORKING FOR TRANSFERRING MULTIPLE SERVICE SESSIONS BETWEEN A MOBILE NETWORK AND A WIRELESS LOCAL AREA NETWORK, AND CORRESPONDING EQUIPMENT

(76) Inventors: Laurence Gras, Velizy (FR); Olivier Marce, Nozay (FR)

Correspondence Address: HARNESS, DICKEY & PIERCE, P.L.C., P.O. BOX 8910, RESTON, VA, 20195, US

(21) Appl. No.: 12/309,877

(22) PCT Filed: Aug. 9, 2007
(86) PCT No.: PCT/EP2007/058282

§ 371 Date: Feb. 2, 2009

(30) Foreign Application Priority Data
Aug. 9, 2006 (FR) 0653324

(51) Int. Cl. H04W 36/00; G06F 15/173

(52) U.S. Cl. 370/331; 709/223

(57) ABSTRACT

A method is dedicated to managing interworking between a WLAN network and a mobile network both connected to a core network comprising at least two GGSN nodes (G1, G2) connected to respective service networks, an SGSN node (NS) connected to the mobile network and to the GGSN nodes, and at least two tunnel termination gateways (T1, T2) connected to the WLAN network and to the GGSN nodes. In case of generation by a mobile station (MS), having set up communication sessions via tunnels between the gateways (T1, T2) and the GGSN nodes (G1, G2), of a message reporting a transfer of the communication sessions from the wireless local area network to the mobile network, the method consists in i) determining communication identifiers of the gateways (T1, T2), ii) using an interface equipment (ED), connected to the gateways (T1, T2) and to the SGSN node (NS) to recover transfer SGSN contexts of the mobile station (MS) from the identified gateways (T1, T2), and iii) at the GGSN nodes (G1, G2) identified by the received transfer SGSN contexts, updating service PDP contexts intended to eliminate an/or modify the tunnels, and establishing new tunnels between the mobile station (MS) and the GGSN nodes (G1, G2) via the SGSN node (NS), to assure continuity of service during the transfer of the communication sessions.

The invention relates to interworking between wireless local area networks (WLAN) and 3GPP mobile communication networks, and more precisely to situations in which a mobile station that has a number of applications (sessions) open to service servers interfaced to a 3GPP mobile network core network via different GGSN nodes needs to keep its sessions open on transfer (handover) from a WLAN network to a 3GPP mobile network or vice-versa.

Here “3GPP networks” means all communication networks having a 3GPP radio interface enabling IP (Internet Protocol) access, and especially second generation (2G) mobile (cellular) networks, for example GSM networks, 2.5G mobile (cellular) networks, for example GPRS/EDGE networks, and third generation (3G) mobile (cellular) networks, for example UMTS or CDMA2000 networks, together with all their variants.

Here “wireless local area networks” means all communication local area networks having a WLAN radio interface enabling IP access (IEEE 802.11, Bluetooth and Hiperlan/2 standards) and especially WiFi and WiMAX networks.

Here “(3GPP/WLAN) interworking” means the possibility for a WLAN network to use certain 3GPP core network infrastructures to enable the user of a hybrid (3GPP/WLAN) mobile station, connected to that WLAN network or on the point of being connected thereto, to access packet services offered by one or more Internet service providers (ISP). Such interworking is defined in particular by release 7 of the 3GPP Technical Specifications TS 23.234 and TS 23.934.

As the person skilled in the art knows, release 7 of the 3GPP/WLAN interworking standard (and more precisely its scenario N° 4) addresses continuity of service on handover of a communication session (involving a service) from a WLAN radio access network to a 3GPP radio access network, and vice-versa. In other words, when a mobile station is using a service via a WLAN radio access network, it must be able to continue to use that service if it quits the 3GPP (respectively WLAN) radio access network to continue its call via a WLAN (respectively 3GPP) radio access network.

For example, a mobile station can use a service via a WLAN radio access network when end-to-end tunnels have been established between that mobile station and a tunnel termination gateway (TTG) of a 3GPP core network, on the one hand, and between that TTG gateway and a gateway GPRS support node (GGSN), on the other hand, the latter providing the connection of the 3GPP core network to the IP network offering the service. Another architecture option sets up a tunnel between a mobile station and a PDG type equipment, but the invention does not apply to this option.

A mobile station can use a service via a 3GPP radio access network if tunnels have been established, on the one hand, between that mobile station and a serving GPRS support node (SGSN) of the 3GPP core network and, on the other hand, between that SGSN node and the GGSN node providing the connection of the 3GPP core network to the IP network offering the service.

In a 3GPP network, the GGSN node is considered an anchor point, including when a mobile station is moving from a WLAN network coverage area to that of a 3GPP (mobile) network. Consequently, during a session transfer (handover) from a WLAN network to a 3GPP network, the SGSN node that is contacted to continue the session must determine the identity of the TTG gateway used until then for that session, in order to obtain from the latter the transfer SGSN context, which includes the service PDP (Packet Data Protocol) context, and initiate a PDP context transfer procedure (which corresponds to the mobile station/GGSN node IP connection). Similarly, during a session transfer (handover) from a 3GPP network to a WLAN network, the gateway TTG that is contacted to continue the session must determine the identity of the SGSN node used until then for that session, in order to obtain from the latter the transfer SGSN context and initiate a PDP context transfer procedure.

From the point of view of the core network, the gateway TTG is therefore treated as an SGSN node, which implies that it must support the location management mechanisms, for example SGSN context transfer, service PDP context update and home location register (HLR) update, in order to maintain continuity of service during a transfer (handover).

The drawback of the architecture based on tunnel termination gateways (TTG) described hereinabove is that it is not adapted to situations in which the user of a mobile station is using more than one (active) service simultaneously, and has therefore set up more than one communication session (or opened more than one application). In these multi-APN (access point name) situations, a plurality of gateways TTG can be involved in a plurality of 3GPP packet-switched services. Remember that the connection of a mobile station of a user to a TTG/GGSN pair is linked to an APN that was requested by that user. Consequently, if a user has requested a plurality of APNs for a plurality of sessions, their mobile station can find itself connected simultaneously to a plurality of tunnel termination gateways. An SGSN node being designed only to recover one PDP context in one node, it is therefore not able to support a WLAN/3GPP or 3GPP/WLAN transfer (handover) simultaneously involving a plurality of communication sessions (plurality of applications).

To eliminate this drawback, it would be possible to modify the mode of operation of the SGSN nodes, but that is not very realistic given the large number of SGSN nodes already installed. Moreover, this imposes modifying the home location register HLR in order to store a plurality of attachment points (here tunnel termination gateways) for a mobile station, instead of the usual single SGSN node.

An object of the invention is therefore to propose a solution for maintaining continuity of service on transferring a plurality of communication sessions (open applications) from the same mobile station (using a plurality of services) of a WLAN radio access network to a 3GPP radio access network, and vice-versa.

To this end it proposes a method dedicated to managing interworking between a wireless local area network (WLAN) and a 3GPP mobile network both connected to a core network comprising at least two GGSN nodes connected to respective service networks, at least one SGSN node connected to the mobile network and to the GGSN nodes, and at least two tunnel termination gateways (TTG) connected to the wireless local area network and to the GGSN nodes, respectively.

This method is characterized in that, in the case of generation by a mobile station, having set up at least two communication sessions via tunnels established between the TTG gateways (respectively the SGSN node), and the GGSN nodes, of a message reporting a transfer of the communication sessions from the wireless local area network (respectively the mobile network) to the mobile network (respectively the wireless local area network), it consists in:

i) determining communication identifiers of said TTG gateways, (respectively a communication identifier of the SGSN node),

ii) using an interface equipment, connected to the TTG gateways and to the SGSN node to recover transfer SGSN contexts of the mobile station from the identified TTG gateways, (respectively from the identified SGSN node), and

iii) at the GGSN nodes identified by the received transfer SGSN contexts, updating service PDP contexts intended to eliminate an/or modify the tunnels, and establishing new tunnels between the mobile station and the GGSN nodes via the SGSN node, (respectively the TTG gateways, to assure continuity of service during the transfer of the communication sessions.

The method of the invention can have other features and in particular, separately or in combination:
in case of transfer of the communication sessions from the wireless local area network to the mobile network, a) the mobile station can send the SGSN node a routing area (zone) update report so that it sends the interface equipment a message requesting the transfer SGSN contexts of the mobile station, and b) on receipt of the request message the interface equipment can recover from an AAA server of the mobile network the communication identifiers of the TTG gateways involved in the sessions of the mobile station being transferred, so as to recover from the identified TTG gateways the transfer SGSN contexts of the mobile station;
in step iii), security operations are effected before effecting the service PDP context updating;
in step iii) the SGSN node can send each of the GGSN nodes a service PDP context update request, and can then send the home location register a message reporting that it is being substituted for the TTG gateways, so that it instructs the AAA server to eliminate the tunnels established between the mobile station and the TTG gateways;
the SGSN node can generate the substitution report message on receipt of substitution confirmation messages coming from the GGSN nodes;
in step iii), on receipt of the substitution report message, the home location register can store a communication identifier of the interface equipment;
in case of transfer of the communication sessions from the mobile network to the wireless local area network, a′) the mobile station can send a first of the TTG gateways a first end-to-end tunnel establishment request containing a user identifier and a first access point name, b′) on receipt of the first request the first TTG gateway can send the AAA server a tunnel establishment authorization request for the mobile station, containing the user identifier and the first access point name, and a request to obtain information for establishing the tunnel, and c′) once in possession of the authorization and the information, the first TTG gateway can start an EAP authentication and authorization procedure for the first access point name, with the mobile station and the AAA server, so as to pre-establish a tunnel between the mobile station and the first TTG gateway;
once the EAP procedure has terminated, the first TTG gateway can send the interface equipment a message requesting the transfer SGSN contexts of the mobile station, and on receipt of the request message the interface equipment can interrogate the home location register to determine the communication identifier of the SGSN node, and can then recover from the identified SGSN node the transfer SGSN contexts of the mobile station, which are associated with the first access point name and with a second access point name, and can then send the first TTG gateway a message containing the transfer SGSN context associated with the first access point name;
in step iii) the first TTG gateway can send a first of the GGSN nodes a service PDP context update request and can then send the AAA server a first message reporting that it is being substituted for the SGSN node for the session associated with the first access point name;
the first TTG gateway can generate the first substitution report message on receipt of a substitution confirmation message coming from the first GGSN node;
in step iii), after the first substitution report message has been sent to the AAA server, the interface equipment can send the second TTG gateway a message containing the transfer SGSN context associated with the second access point name. On receipt of the message the second TTG gateway can start an EAP authentication and authorization procedure for the second access point name with the mobile station and the AAA server so as to pre-establish a tunnel between the mobile station and the second TTG gateway;
in step iii), after receiving the message containing the transfer SGSN context associated with the second access point name, the second TTG gateway can send a second of the GGSN nodes a service PDP context update request and can then send the AAA server a message reporting that it is being substituted for the SGSN node for the session associated with the second access point name;
the second TTG gateway can generate the second substitution report message on receipt of a substitution confirmation message coming from the second GGSN node. In this case, on receipt of the second substitution report message the AAA server can send the home location register a message reporting that the TTG gateways have been substituted for the SGSN node, in order for it to inform the SGSN node of that substitution, and on receipt of this substitution information the SGSN node can eliminate the tunnels until then established between it and the mobile station, and can then send the home location register an acknowledgement message informing it that it has eliminated the tunnels to the mobile station. Moreover, on receipt of the acknowledgement message the home location register can send the AAA server a message informing it that the tunnels to the mobile station have been eliminated, then on receipt of this elimination report message the AAA server can send the first TTG gateway an end of new tunnel establishment procedure acknowledgement message, and on receipt of this acknowledgement message the first TTG gateway can send the mobile station an end of procedure report message;
the communication identifiers can be IP addresses and/or ISDN identifiers, for example.

The invention also proposes interface equipment for a 3GPP core network comprising processor means responsible, if they receive a message requesting transfer SGSN contexts of a mobile station seeking to transfer between the wireless local area network and the mobile network communication sessions set up via tunnels between the GGSN nodes and the TTG gateways (respectively the SGSN node), to recover the transfer SGSN contexts of the mobile station from the TTG gateways (respectively the SGSN node) in order to communicate them to the SGSN node (respectively to the TTG gateways), so that it can be substituted (respectively they can be substituted) for the TTG gateways (respectively the SGSN node), and to establish new tunnels between it (respectively them) and the mobile station.

The interface equipment can have other features and in particular, separately or in combination:
its processor means can be responsible, in case of transfer of the communication sessions from the wireless local area network to the mobile network and of reception from the SGSN node of a message requesting the transfer SGSN contexts of the mobile station, for recovering from an AAA server of the mobile network the communication identifiers of the TTG gateways involved in the sessions of the mobile station being transferred, and can then recover from the identified TTG gateways the transfer SGSN contexts of the mobile station;
its processor means can be responsible, in case of transfer of the communication sessions from the mobile network to the wireless local area network and of reception from a first of the TTG gateways of a message requesting the transfer SGSN contexts of the mobile station, for sending a request to the home location register so as to recover the communication identifier of the SGSN node, and then to recover from the identified SGSN node, by means of another request, the transfer SGSN contexts of the mobile station, which are associated with first and second access point names, and then to send the first TTG gateway a message containing the transfer SGSN context associated with the first access point name;
its processor means can be responsible, in case of substitution of the SGSN node by the first TTG gateway, for sending the second TTG gateway a message containing the transfer SGSN context associated with the second access point name.

Other features and advantages of the invention will become apparent on reading the following detailed description and examining the appended drawings, in which:

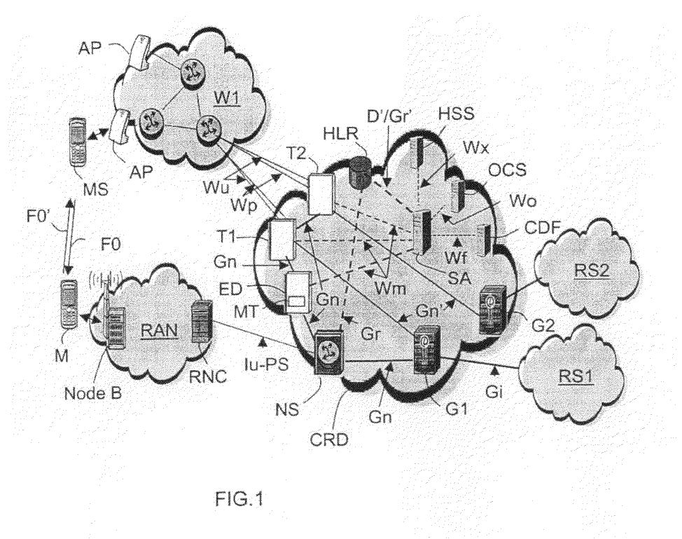

FIG. 1 is a highly diagrammatic and functional illustration of a 3GPP mobile network comprising a 3GPP radio access network and a 3GPP core network provided with a tunnel termination gateway connected to a WLAN radio access network, an SGSN node connected to the 3GPP radio access network, one embodiment of an interface equipment according to the invention, two gateways TTG, and two GGSN nodes connected to two service networks,

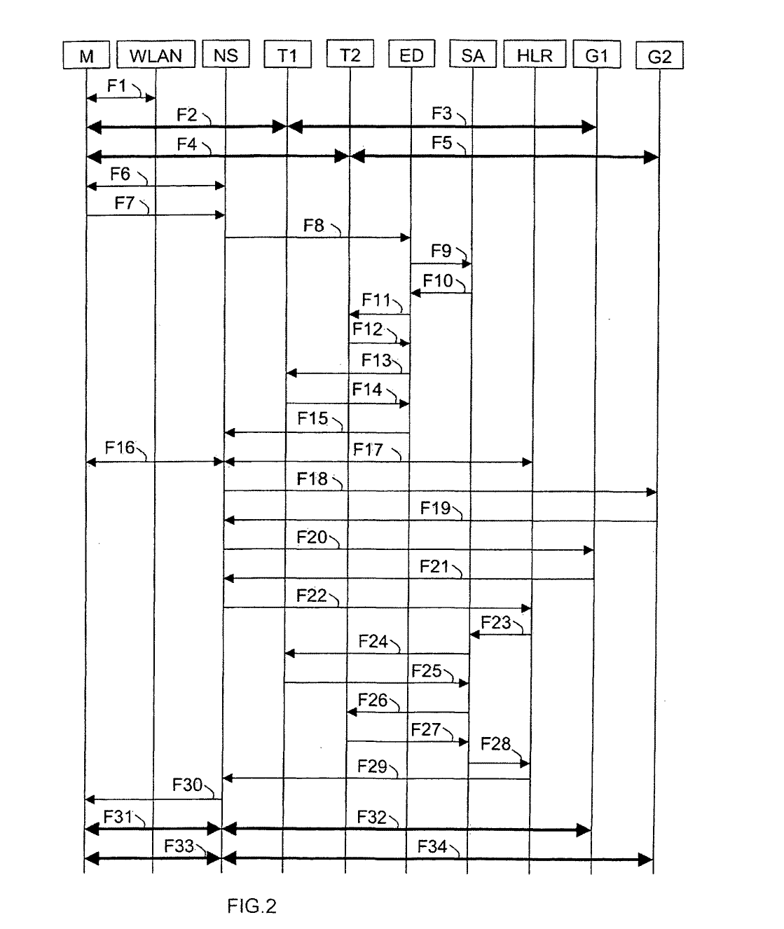

FIG. 2 is a diagrammatic illustration of the main steps of one example of a method of the invention for transferring a communication session from the WLAN radio access network to the 3GPP radio access network of FIG. 1, and

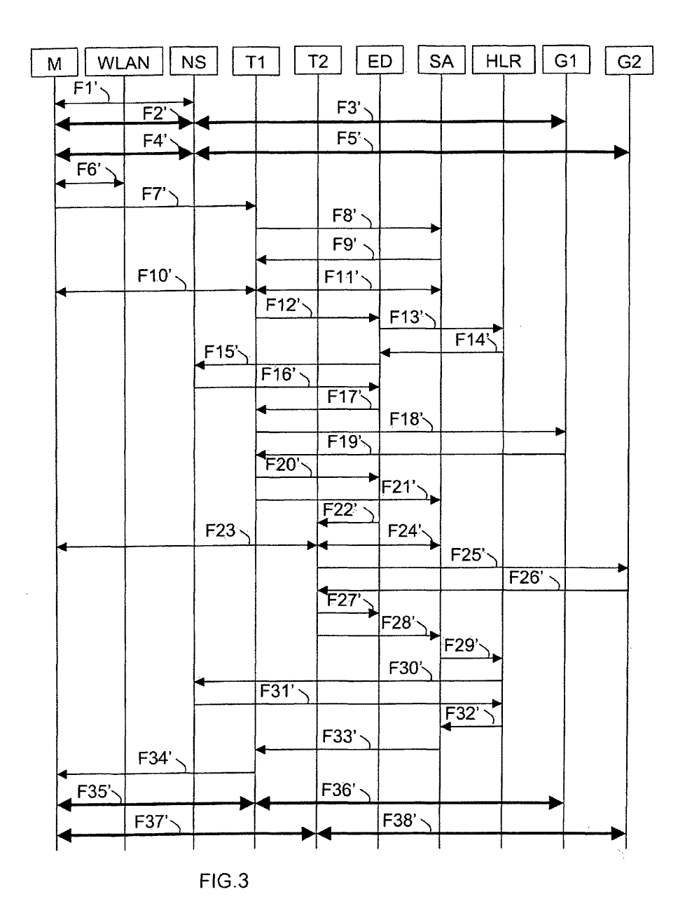

FIG. 3 is a diagrammatic illustration of the main steps of one example of a method of the invention for transferring a communication session from the 3GPP radio access network to the WLAN radio access network of FIG. 1.

The appended drawings constitute part of the description of the invention as well as contributing to the definition of the invention, if necessary.

An object of the invention is to maintain continuity of service on transferring a plurality of (at least two) communication sessions or applications (involving a plurality of services used simultaneously by a mobile station) from a WLAN radio access network to a 3GPP radio access network and vice-versa.

It is considered hereinafter by way of nonlimiting and illustrative example that the 3GPP radio access network is part of a UMTS type 3GPP mobile (cellular) network. However, the invention is not limited to that type of mobile network. In fact it relates to all communication networks having a 3GPP radio interface enabling IP access and in particular 2G networks (for example GSM networks), 2.5G networks (for example GPRS/EDGE networks), and 3G networks (for example UMTS or CDMA2000 networks), together with all their variants and equivalents.

It is further considered hereinafter by way of nonlimiting and illustrative example that the WLAN radio access network is part of a wireless local area network (WLAN) of WiFi or WiMAX type. However, the invention is not limited to that type of WLAN network. In fact it relates to all wireless local area networks having a WLAN radio interface enabling IP access (IEEE 802.11, Bluetooth and Hiperlan/2 standards).

The invention proposes a method dedicated to the management of interworking between a wireless local area network (WLAN) and a 3GPP mobile network. That method can be implemented by means of a network architecture of the type shown in FIG. 1 and comprising a 3GPP core network CRD, at least first and second networks (sets) of services (packet services) RS1 and RS2 offered by Internet service providers (ISPs) or Intranet service providers, at least one 3GPP radio access network RAN, and at least one WLAN radio access network W1 of a WLAN network. It will be noted that the invention applies to any situation in which the core network CRD is connected (via GGSN nodes) to at least two networks (sets) of services.

It is considered hereinafter that the 3GPP radio access network RAN and the 3GPP core network CRD are part of the same UMTS network of which the users of the mobile stations MS are customers. Consequently, in the example described hereinafter the GPP core network CRD constitutes a home core network for the mobile stations MS. However, this is not obligatory.

It is important to note that the invention relates only to 3GPP/WLAN hybrid mobile stations MS, i.e. mobile stations having a communication card (for example of UICC type provided with a (U)SIM) enabling them to be connected both to WLAN radio access networks (WAN) and to 3GPP radio access networks (RAN). It can therefore be a question of any type of mobile communication equipment and in particular a mobile telephone, a portable computer or a personal digital assistant (PDA) equipped with a card of the type cited above.

The method of the invention must be used each time that a mobile station MS has set up at least two communication sessions with at least two networks (sets) of services RS1 and RS2, through the intermediary of a WLAN radio access network W1 (respectively a 3GPP radio access network RAN) and at least its home core network CRD, in order to use simultaneously at least two different services, and that mobile station MS must be connected to a 3GPP radio access network RAN (respectively a WLAN radio access network W1), where applicable a visited network, in order to continue the communication session used for said services.

The method is therefore applied either when tunnels have been established between a mobile station MS and at least two tunnel termination gateways (TTGs) T1 and T2 (belonging to the core network CRD and connected to the WLAN radio access network W1) and between the latter and at least two GGSN (Gateway GPRS Support Node) nodes G1 and G2 (belonging to the core network CRD and connected to the service networks RS1 and RS2), or when tunnels have been established between a mobile station MS and an SGSN (Serving GPRS Support Node) node NS (belonging to the core network CRD and connected to the 3GPP radio access network RAN) and between the latter and at least two GGSN nodes G1 and G2.

The method of the invention consists in effecting the three phases described hereinafter each time that a mobile station MS that has set up at least two communication sessions via tunnels established between the tunnel termination gateways T1 and T2 (or the SGSN node NS) and the GGSN nodes G1 and G2, generates a message reporting the requirement to transfer its communication sessions from the WLAN radio access network W1 (or the 3GPP radio access network RAN) to the 3GPP radio access network RAN (or the WLAN radio access network W1).

The first phase consists in determining communication identifiers of the tunnel termination gateways T1 and T2 (or a communication identifier of the SGSN node NS).

The second phase consists in using a new interface equipment ED, connected to the tunnel termination gateways T1 and T2 and to the SGSN node NS, to recover transfer SGSN contexts of the mobile station MS from the tunnel termination gateways T1 and T2 (or from the SGSN node NS) identified during the first phase.

The third phase consists in effecting a service PDP context update at the GGSN nodes G1 and G2 identified by the transfer SGSN contexts recovered during the second phase, in order to eliminate and/or modify the tunnels established between the mobile station MS and the GGSN nodes G1 and G2, via the tunnel termination gateways T1 and T2 (or the SGSN node NS), and establish new tunnels between the mobile station MS and the GGSN nodes G1 and G2, via the SGSN node NS (or the tunnel termination gateways T1 and T2), in order to assure continuity of service during the transfer of the communication sessions of the mobile station MS.

The above three phases are described in detail hereinafter in the context of first and second embodiments of the method, respectively corresponding to transferring two communication sessions of a mobile station MS from the WLAN radio access network W1 to the 3GPP radio access network RAN (described with reference to FIG. 2) and to transferring two communication sessions of a mobile station MS from the 3GPP radio access network RAN to the WLAN radio access network W1 (described with reference to FIG. 3).

The first embodiment of the method of the invention is described next with reference to FIGS. 1 and 2.

This first embodiment relates to a situation in which the mobile station MS has already set up two communication sessions with the first and second service networks RS1 and RS2 via tunnels established between it and the GGSN nodes G1 and G2 (respectively connected to the first and second service networks RS1 and RS2) via the tunnel termination gateways T1 and T2. In this situation, a first access point name APN1 has been assigned to a first pair comprising the first tunnel termination gateway T1 and the first GGSN node G1 and a second access point name APN2 has been assigned to a second pair comprising the second tunnel termination gateway T2 and the second GGSN node G2.

The procedure for setting up an initial communication session via the WLAN radio access network W1 is well known to the person skilled in the art. For this reason it is not described in detail here. Suffice to say that a mobile station MS can be connected to the WLAN radio access network W1 via an access point AP. An access point AP is connected to the core network CRD either by at least one router of its WLAN network and tunnel termination gateways T1 and T2 via an interface called the Wp interface or directly to tunnel termination gateways T1 and T2 via the Wp interface if those tunnel termination gateways also implement the router function. Each tunnel termination gateway T1, T2 is connected, via an interface called the Gn′ interface, to a GGSN node G1, G2 that serves as an access point, via an interface called the Gi interface, to one or more packet-switched (PS) services offered by at least an application server of a service network RS1, RS2, for example. Each tunnel termination gateway T1, T2 has at least one communication identifier, for example an IP address, and where applicable an ISDN number (identifier).

When a communication session must be set up for a mobile station MS and for a given service, the station must first find the communication identifier (for example the IP address) of a tunnel termination gateway T1 or T2. For example, the mobile station MS can effect a domain name system (DNS) request for this purpose (arrow F1 in FIG. 2). Then, once it has the IP address of a tunnel termination gateway T1 or T2, the mobile station MS sends the tunnel termination gateway T1 or T2, via an access point AP of the WLAN radio access network W1, an end-to-end tunnel establishment request (including in particular User-ID and W-APN fields), conforming to the 3GPP Technical Specification TS 23.234. This end-to-end tunnel is of the VPN/IPSec type, for example. Once it has been established between the mobile station MS and a tunnel termination gateway T1 or T2 (arrow F2 or F4 in FIG. 2), via an interface called the Wu interface, the tunnel termination gateway T1 or T2 establishes, via the Gn′ interface, another end-to-end tunnel to the GGSN node G1 or G2 that provides access to the service that is the subject of the requested session (arrow F3 or F5 in FIG. 2). This other end-to-end tunnel is of the GPRS tunneling protocol (GTP) type, for example.

Via an interface called the Gr′ interface, the tunnel termination gateway T1 or T2 sends a communication identifier of the mobile station MS and at least its own IP address, and generally its own ISDN number (identifier) to a home location register (HLR) of the core network CRD in order for it to store them in corresponding relationship to each other.

When the mobile station MS is getting ready to quit the WLAN radio access network W1 to be connected to the 3GPP radio access network RAN (arrow F0 in FIG. 1), it starts a communication session transfer (handover) procedure.

As previously indicated, it is precisely at this stage that the method of the invention becomes operative.

In this first embodiment of the method of the invention, an SGSN node NS, connected via an interface called the Gn interface to the GGSN nodes G1 and G2, must take over from the tunnel termination gateways T1 and T2 involved up to this point in the two sessions of the mobile station MS.

In the case of a UMTS network, the 3GPP radio access network RAN comprises base stations known as Node Bs and radio network controllers (RNC). An RNC is generally connected to at least one Node B and to the 3GPP core network CRD by one of its SGSN nodes NS via an interface called the lu-PS interface. Each SGSN node NS has at least one communication identifier, for example an IP address, and possibly an ISDN number (identifier), and is connected to at least one GGSN node of the 3GPP core network CRD via a tunnel, preferably of the GPRS Tunneling Protocol (GTP) type, which uses an interface called the Gn interface.

When (in sessions) the mobile station MS quits the radio coverage area of the WLAN access network W1 and enters the radio coverage area of the 3GPP radio access network RAN, it sets up a UMTS connection to the SGSN node NS that is connected to the GGSN nodes G1 and G2 that provide access to the services that are the subjects of the sessions, via a Node B and the associated RNC (arrow F6 in FIG. 2). The mobile station MS then generates for sending to the SGSN node NS a routing area (zone) updating report, for example of the “Routing Area Update Request( )” type. That report is sent to the SGSN node NS by the WLAN radio access network W1 (arrow F7 in FIG. 2).

When the SGSN node NS receives the routing area update report, it must determine the transfer SGSN contexts (subjects of the sessions to be transferred) used by the mobile station MS in order to be substituted for the tunnel terminal gateways T1 and T2. For this purpose, it generates a message requesting the transfer SGSN contexts and then sends that message (arrow F8 in FIG. 2) to the interface equipment ED that, in accordance with the invention, is responsible for recovering the transfer SGSN contexts relating to the sessions currently being transferred involving the tunnel termination gateways T1 and T2 to which it is connected (coupled). The request message contains information such as, in particular, the communication identifier of the mobile station MS. Remember that the home location register HLR stores this information in corresponding relationship for at least one communication identifier of each tunnel termination gateway T1, T2 providing access to each service that is the subject of a session being transferred.

Each transfer SGSN context that must be recovered contains a service PDP context and security elements specific to the mobile station MS concerned. A service PDP (Packet Data Protocol) context represents the definition of a current service. It includes the IP address of the GGSN node G1, G2 that serves as an access point to the service concerned, and where applicable the ISDN number (identifier) of said GGSN node G1, G2.

Moreover, the message requesting the transfer SGSN contexts is of the “SGSN context Request( )” type, for example.

The interface equipment ED is a new item of network equipment proposed by the invention. It is connected, firstly, to the SGSN node NS, for example via an interface called the Gn interface, secondly, to each tunnel termination gateway T1, T2, for example via another Gn interface, and, thirdly, to an AAA (Authentication, Authorization and Accounting) server SA of the core network CRD, for example via an interface called the Wm interface.

This interface equipment ED can, for example, constitute a proxy tunnel termination gateway TTG, i.e. a gateway supporting a subset of the functions supported by a standard tunnel termination gateway T1, T2. More precisely, the interface equipment ED is responsible i) for receiving requests to obtain SGSN contexts, ii) for identifying either tunnel termination gateways TTG by means of the AAA type server SA or an SGSN node by means of the home location register HLR, until this point connected to a mobile station MS, and iii) for requesting the corresponding SGSN contexts in order to send them to the elements that have requested them, namely new tunnel termination gateways TTG or a new SGSN node. Just like the terminal termination gateways T1 and T2, the interface equipment ED has at least one communication identifier, for example an IP address, and where applicable an ISDN number (identifier). It will be noted that the interface equipment ED can be installed in the AAA server SA.

It will be noted that a core network can include more than one interface equipment ED according to the invention, for example for security and/or load distribution reasons.

The transfer SGSN contexts are recovered in two phases: a first in which the interface equipment ED must recover at least one communication identifier of each tunnel termination gateway T1, T2 to which the transfer relates, and a second in which the interface equipment ED must recover the transfer SGSN contexts from the tunnel termination gateways T1 and T2 that it has identified.

The interface equipment ED includes, for example, a processor module MT responsible for recovering from the AAA server the communication identifiers of the tunnel termination gateways T1 and T2. Consequently, when the interface equipment ED receives from the SGSN node NS a message of the “SGSN Context Request( )” type, for example, its processor module MT generates a request, for example of the “TTG Location Request( )” type, containing the information necessary for recovering the communication identifiers of the tunnel termination gateways TTG (here T1 and T2) that are involved in the sessions of the mobile station MS. The interface equipment ED sends this message to the AAA server SA via the interface Wm (arrow F9 in FIG. 2).

When the AAA server SA receives the “TTG Location Request( )” type message, for example, it searches its memory or database for the communication identifiers, for example the IP addresses, of the tunnel termination gateways TTG enabling execution of the sessions being transferred from the mobile station MS. The AAA server SA then generates a response message containing those communication identifiers and sends it to the interface equipment ED, via the interface Wm (arrow F10 in FIG. 2).

On receiving the communication identifiers, the processor module MT generates a new message requesting the (first) transfer SGSN context of the first session (associated with APN1) of the mobile station MS that requested the transfer. This message (requesting the first transfer SGSN context) is of the “SGSN Context Request( )” type, for example. The interface equipment ED then sends this “SGSN Context Request( )” type message, for example, to the first tunnel termination gateway T1 identified in the response message received, via the interface Gn (arrow F11 in FIG. 2).

In response to the received message, the first tunnel termination gateway T1 generates a response message containing the required first transfer SGSN context and sends it to the interface equipment ED, via the interface Gn (arrow F12 in FIG. 2).

On receiving this first transfer SGSN context, the processor module MT generates a new message requesting the (second) transfer SGSN context of the second session (associated with APN2) from the mobile station MS that requested the transfer. This message (requesting the second transfer SGSN context) is of the “SGSN context Request( )” type, for example. The interface equipment ED then sends this “SGSN context request( )” type message, for example, to the second tunnel termination gateway T2 identified in the response message received, via the interface Gn (arrow F13 in FIG. 2).

In response to the received message, the second tunnel termination gateway T2 generates a response message containing the required second transfer SGSN context and sends it to the interface equipment ED via the interface Gn (arrow F14 in FIG. 2).

Once in possession of the two transfer SGSN contexts, the processor module MT inserts them into a response message that is sent to the SGSN node NS via the Gn interface (arrow F15 in FIG. 2).

When the SGSN node NS receives the response message, it can effect security operations with respect to the mobile station MS and the home location register HLR before updating the service PDP contexts (arrows F16 and F17 in FIG. 2). These security operations consist in exchanging keys for making exchanges secure, for example.

Once these security operations, if any, have been effected, the SGSN node NS updates the service PDP contexts in order to eliminate and/or modify the end-to-end tunnels (of VPN/IPSec and GTP type) established between the mobile station MS and the GGSN nodes G1 and G2, via the tunnel termination gateways T1 and T2 (arrows (F2 and F3) and (F4 and F5) in FIG. 2), to enable execution of the sessions being transferred.

For this purpose, it generates a first service PDP context update request, for example. This first request is of the “Update PDP Context Request( )” type, for example. It is intended to inform the first GGSN node G1 that the SGSN node NS is being substituted for the first tunnel termination gateway T1 for the first service session of the mobile station MS. It consequently includes the communication identifier(s) of the SGSN node NS, the identifier of the mobile station MS, and other information linked to the latter. The SGSN node NS sends the first request to the first GGSN node G1 identified by the received first transfer SGSN context via the interface Gn (arrow F18 in FIG. 2).

On receipt of this first request, the first GGSN node G1 stores the information that it contains and then sends the SGSN node NS a first acknowledgement message (arrow F19 in FIG. 2). It is important to note that this updating of the first PDP context does not actually eliminate the GTP tunnel associated with the first session being transferred, but modifies it. In fact, the effect of this is merely to replace its first tunnel termination gateway T1 end with another SGSN node NS end, the IP address of the first service remaining the same.

On receipt of this first acknowledgement message, the SGSN node NS generates a second service PDP context update request, for example. The second request is of the “Update PDP Context Request( )” type, for example. It is intended to inform the second GGSN node G2 that the SGSN node NS is being substituted for the second tunnel termination gateway T2 for the second service session of the mobile station MS. It consequently includes the communication identifier(s) of the SGSN node NS, the identifier of the mobile station MS, and other information linked to the latter. The SGSN node NS sends the second request to the second GGSN node G2 identified by the received second transfer SGSN context via the interface Gn (arrow F20 in FIG. 2).

On receipt of this second request, the second GGSN node G2 stores the information that it contains and then sends the SGSN node NS a second acknowledgement message (arrow F21 in FIG. 2). It is important to note that this updating of the second PDP context does not actually eliminate the GTP tunnel associated with the second session being transferred, but modifies it. In fact, the effect of this is merely to replace its second tunnel termination gateway T2 end with another SGSN node NS end, the IP address of the second service remaining the same.

Once the SGSN node NS has received the two acknowledgement messages, it must update the home location register HLR. For this purpose, it generates a message to report the substitution of the access points of the mobile station MS for the sessions being transferred, for example. This message is of the “Update Location( )” type, for example. It consequently includes the communication identifier(s) of the SGSN node NS and the identifier of the mobile station MS. The SGSN node NS sends the message to the home location register HLR via the interface Gr (arrow F22 in FIG. 2).

On receipt of this message, the home location register HLR updates its memory or database with the information that it contains and then sends the AAA server SA a message requesting elimination of the end-to-end (VPN/IPSec) tunnels established between the mobile station MS and the tunnel termination gateways T1 and T2 via an interface D′/Gr′ (arrow F23 in FIG. 2). This message is of the “Cancel Location( )” type, for example. It consequently includes the communication identifier(s) of the SGSN node NS, the identifier of the mobile station MS, the communication identifiers of the tunnel termination gateways T1 and T2 that must be replaced by that (those) of the SGSN node NS in corresponding relationship to the identifier (IMSI) of the mobile station MS.

On receipt of this message, the AAA server SA updates its memory or database with the information that it contains and then sends the first tunnel termination gateway T1 identified in said message, via the interface Wm (arrow F24 in FIG. 2), a first request for elimination of the end-to-end (VPN/IPSec) tunnel established between it and the mobile station MS. This first request is of the “Tunnel Disconnection Command( )” type, for example.

On receipt of this first request, the first tunnel termination gateway T1 eliminates the identified VPN/IPSec tunnel and then sends the AAA server SA a first acknowledgement message via the interface Wm (arrow F25 in FIG. 2).

On receipt of this first acknowledgement message, the AAA server SA sends the second tunnel termination gateway T2 identified in said message, via the interface Wm (arrow F26 in FIG. 2), a second request for elimination of the end-to-end (VPN/IPSec) tunnel established between it and the mobile station MS. This second request is of the “Tunnel Disconnection Command( )” type, for example.

On receipt of this second request, the second tunnel termination gateway T2 eliminates the identified VPN/IPSec tunnel and then sends the AAA server SA a second acknowledgement message via the interface Wm (arrow F27 in FIG. 2).

Once the AAA server SA has received the two acknowledgement messages, it sends the home location register HLR an acknowledgement message via the interface Wm (arrow F28 in FIG. 2) to inform it that both the VPN/IPSec tunnels have indeed been eliminated. This message is of the “Cancel Lock Ack( )” type, for example.

On receipt of this acknowledgement message, the home location register HLR sends the SGSN node NS an acknowledgement message via the interface Gr (arrow F29 in FIG. 2) to inform it that the updates have indeed been effected. This message is of the “Update Location Ack( )” type, for example.

On receipt of this acknowledgement message, the SGSN node NS sends the mobile station MS (which requested the transfer) a routing area update acceptance message via the interface lu-PS (arrow F30 in FIG. 2), in order to inform it that it can now establish new tunnels to continue its service sessions via the 3GPP radio access network RAN. This message is of the “Routing Area Update Accept( )” type, for example.

On receipt of this message, the mobile station MS then establishes two new tunnels between itself and the SGSN node NS (arrows F31 and F33 in FIG. 2), the other two “new” (GTP) tunnels having been modified before this (change of end) in order to be established between the SGSN node NS and the GGSN nodes G1 and G2 (arrows F32 and F34 in FIG. 2).

Thanks to these new tunnels (arrows F31 to F34), continuity of service is assured for the mobile station MS during transfer of its communication sessions from the WLAN network to the 3GPP mobile network.

The second embodiment of the method of the invention is described next with reference to FIGS. 1 and 3.

The second embodiment relates to a situation in which the mobile station MS has already set up two communication sessions with the first service network RS1 and the second service network RS2 via tunnels established between it and the GGSN nodes G1 and G2 (connected to the first service network RS1 and the second service network RS2, respectively), via the SGSN node NS (arrows F1′ to F5′ in FIG. 3). In this situation, a first access point name APN1 has been assigned to the first pair (SGSN node NS, first GGSN node G1) and a second access point name APN2 has been assigned to the second pair (SGSN node NS, second GGSN node G2).

The procedure for setting up an initial communication session via the 3GPP radio access network RAN is well known to the person skilled in the art. It is therefore not described in detail here. Suffice to say that a mobile station MS can be connected to the 3GPP radio access network RAN via one of its base stations (Node B). Such a Node B is connected to a radio network controller (RNC) that is also part of the 3GPP radio access network RAN. The RNC is connected to the 3GPP core network CRD by one of its SGSN nodes NS via the lu-PS interface. This SGSN node NS has at least one communication identifier, for example an IP address, and generally an ISDN number (identifier), and is connected, via a tunnel that is preferably a GTP tunnel, using an interface called the Gn interface, to at least one of the GGSN nodes G1, G2.

When a communication session must be set up for a mobile station MS and for a given service, the station must first find a communication identifier of the SGSN node NS that is connected to the GGSN node that provides access to the service to which the session relates. The mobile station MS then sends its tunnel establishment request to the SGSN node concerned. Once the tunnels have been established, the SGSN node NS sends the home location register HLR, via an interface called the Gr interface, an identifier of the mobile station MS and at least its own IP address and generally its own ISDN number (identifier), in order for it to store them in corresponding relationship to each other.

When the mobile station MS is getting ready to quit the 3GPP radio access network RAN to be connected to a WLAN radio access network W1 (arrow F0′ in FIG. 1), it begins a communication session transfer (handover) procedure.

As previously indicated, it is precisely at this stage that the method of the invention becomes operative.

In this second embodiment of the method of the invention, the tunnel termination gateways T1 and T2 connected to the GGSN nodes G1 and G2 via the interface Gn must take over from the SGSN node NS that until this point was involved in the two sessions of the mobile station MS.

When (in sessions) the mobile station MS quits the radio coverage area of the 3GPP radio access network RAN and enters the radio coverage area of the WLAN radio access network W1, it sets up a WLAN connection to the WLAN network (arrow F6′ in FIG. 3). The mobile station MS must then find the IP address of the tunnel termination gateway, here the gateway T1, that is connected to the GGSN node G1 that provides access to the first service that is the subject of the first session. For this purpose it effects a DNS (Domain Name System) request. Then, once it has the IP address of the first tunnel termination gateway T1, the mobile station MS sends that first tunnel termination gateway T1, via an access point AP of the WLAN radio access network W1 (arrow F7′ in FIG. 3), a request to establish an end-to-end tunnel, for example of the “Tunnel Establishment Request( )” type, including the identifier of the user of the mobile station MS (User-ID) and the access point name APN1 associated with the first session, in accordance with the 3GPP Technical Specification TS 23.234.

When the first tunnel termination gateway T1 receives the tunnel establishment request, it must first generate for sending to the AAA server (arrow F8′ in FIG. 3) a request i) for authorization to establish tunnels for the mobile station MS concerned, containing the user identifier (User-ID) and the first access point name APN1, and ii) for information for establishing the tunnel. This request is of the “Access Request/Identity( )” type, for example.

On receipt of this request, the AAA server SA generates for sending to the first tunnel termination gateway T1 that has interrogated it (arrow F9′ in FIG. 3) a response message containing a tunnel establishment authorization and information for establishing the tunnel between it and the mobile station MS.

On receipt of this response message, the first tunnel termination gateway T1 can start an EAP authentication and authorization procedure for the first session associated with the first access point name APN1, on the one hand with the mobile station MS (arrow F10′ in FIG. 3), and on the other hand with the AAA server SA (arrow F11′ in FIG. 3). This procedure pre-establishes a tunnel between the mobile station MS and the first tunnel termination gateway T1.

Once the EAP procedure has terminated, the first tunnel termination gateway T1 must determine the transfer SGSN contexts (that are the subjects of the sessions to be transferred) used by the mobile station MS in order for it to be substituted for the SGSN node NS involved in the transfer of the sessions. For this purpose, it generates a message requesting the transfer SGSN contexts and then sends that message (arrow F12′ in FIG. 3) to the interface equipment ED which, according to the invention, is responsible for recovering the transfer SGSN contexts relating to the sessions being transferred involving the SGSN node NS to which it is connected (coupled). The request message contains information such as the communication identifier of the mobile station MS.

This message requesting the transfer SGSN contexts is of the “SGSN Context Request( )” type, for example.

On receipt of this request message, the interface equipment ED generates for sending to the home location register HLR (arrow F13′ in FIG. 3) a request to send it at least one communication identifier of the SGSN node NS to which the sessions of the mobile station MS relate. This request includes at least the communication identifier of the mobile station MS. It is of the “Location Request( )” type, for example.

On receipt of this request, the home location register HLR recovers from its memory or database the communication identifier(s) (for example the IP address) of the SGSN node NS that is involved in the open sessions of the mobile station MS. It then generates for sending to the interface equipment ED (arrow F14′ in FIG. 3) a response message containing the communication identifier(s) of the SGSN node NS.

On receipt of this response message, the processor module MT of the interface equipment ED must recover the transfer SGSN contexts from the SGSN node NS. For this purpose, it generates a message requesting the transfer SGSN contexts of the sessions of the mobile station MS that requested the transfer. This message is also of the “SGSN Context Request( )” type, for example. The interface equipment ED sends this SGSN Context Request( ) type message, for example, via the interface Gn (arrow F15′ in FIG. 3), to the SGSN node NS identified in the request message sent by the first tunnel termination gateway T1.

In response to this received message, the SGSN node NS generates a response message containing the requested first and second transfer SGSN contexts and sends it to the interface equipment ED via the interface Gn (arrows F16′ in FIG. 3).

On receipt of these transfer SGSN contexts, the processor module MT generates a response message containing said transfer SGSN contexts. The interface equipment ED then sends this response message to the first tunnel termination gateway T1 that originated the session transfer and that it has previously made responsible for recovering the contexts, via the interface Gn (arrows F17′ in FIG. 3).

When the first tunnel termination gateway T1 receives the response message, it begins updating the service PDP contexts intended to eliminate and/or modify the end-to-end tunnels (of VPN/IPSec and GTP types) established between the mobile station MS and the GGSN nodes G1 and G2, via the SGSN node NS (arrows (F2′ and F3′) and (F4′ and F5′) in FIG. 3), to enable execution of the sessions being transferred.

For this purpose, it generates a first service PDP context update request, for example. This first request is of the “Update PDP Context Request( )” type, for example. It is intended to inform the first GGSN node G1 that the first tunnel termination gateway T1 is being substituted for the SGSN node NS for the first service session of the mobile station MS. It consequently includes the communication identifier(s) of the first tunnel termination gateway T1, the identifier of the mobile station MS and other information linked to the latter. The first tunnel termination gateway T1 sends the first request to the first GGSN node G1 identified by the first received transfer SGSN context, via an interface called the Gn′ interface (arrow F18′ in FIG. 3).

On receipt of this first request, the first GGSN node G1 stores the information that it contains and then sends the first tunnel termination gateway T1 a first acknowledgement message that constitutes a substitution confirmation message (arrow F19′ in FIG. 3). It is important to note that this updating of the first PDP context does not actually eliminate the GTP tunnel associated with the first session being transferred, but modifies it. In fact, the effect of this is merely to replace its SGSN node NS end with another first tunnel termination gateway T1 end, the IP address of the first service remaining the same.

On receipt of this first acknowledgement message, the first tunnel termination gateway T1 sends an acknowledgement message to the interface equipment ED (arrow F20′ in FIG. 3) to inform it that it has indeed recovered the transfer SGSN contexts. It will be noted that this optional step could occur before the generation of the first service PDP context update request (arrow F18′).

The first tunnel termination gateway T1 then sends the AAA server (arrow F21′ in FIG. 3) a first message to inform it that it is being substituted for the SGSN node NS for the first session associated with the first access point name APN1. This first message is of the “Tunnel Connection Report( )” type, for example. The AAA server then stores this substitution information.

The processor module MT of the interface equipment ED then generates a message containing the second transfer SGSN context. The interface equipment ED then sends this message via the interface Gn (arrow F22′ in FIG. 3) to the second tunnel termination gateway T2 previously identified in order for it to update the second PDP context.

On receipt of this message, the second tunnel termination gateway T2 can start an EAP procedure for the second session associated with the second access point name APN2, on the one hand with the mobile station MS (arrow F23′ in FIG. 3), and on the other hand with the AAA type server SA (arrow F24′ in FIG. 3).

Once the EAP procedure has terminated, the second tunnel termination gateway T2 generates a second service PDP context update request, for example. The second request is of the “Update PDP Context Request( )” type, for example. It is intended to inform the second GGSN node G2 that the second tunnel termination gateway T2 is being substituted for the SGSN node NS for the second service session of the mobile station MS. It consequently includes the communication identifier(s) of the second tunnel termination gateway T2, the identifier of the mobile station MS and other information linked to the latter. The second tunnel termination gateway T2 sends the second request to the second GGSN node G2, identified by the received second transfer SGSN context, via the interface Gn′ (arrow F25′ in FIG. 3).

On receipt of this second request, the second GGSN node G2 stores the information that it contains and then sends the second tunnel termination gateway T2 a second acknowledgement message that constitutes a substitution confirmation message (arrow F26′ in FIG. 3). It is important to note that this updating of the second service PDP context does not actually eliminate the GTP tunnel associated with the second session being transferred, but modifies it. In fact, the effect of this is merely to replace its SGSN node NS end with another second tunnel termination gateway T2 end, the IP address of the second service remaining the same.

On receipt of this second acknowledgement message, the second tunnel termination gateway T2 can send an acknowledgement message to the interface equipment ED (arrow F27′ in FIG. 3) to inform it that it has indeed updated the second service PDP context.

The second tunnel termination gateway T2 then sends the AAA server (arrow F28′ in FIG. 3) a second message to inform it that it is being substituted for the SGSN node NS for the second session associated with the second access point name APN2. This second message is of the “Tunnel Connection Report( )” type, for example. The AAA server then stores this substitution information in its memory or database. It must then update the home location register HLR. For this purpose, it generates a message to report the substitution of the access points of the mobile station MS for the sessions being transferred, for example. This message is of the “Update Location( )” type, for example. It includes the identifier of the mobile station MS. The AAA server sends the message to the home location register HLR via an interface called the D′/Gr′ interface (arrow F29′ in FIG. 3).

On receipt of this message, the home location register HLR updates its memory or database with the information that it contains and then sends the SGSN node NS a message requesting elimination of the end-to-end tunnels established between it and the mobile station MS, via the interface Gr (arrow F30′ in FIG. 3). This message is of the “Cancel Location( )” type, for example. Consequently it includes at least the identifier of the mobile station MS.

On receipt of this message, the SGSN node NS eliminates the tunnels established with the identified mobile station MS and then sends the home location register HLR, via the interface Gr (arrow F31′ in FIG. 3), an acknowledgement message to inform it that it has indeed eliminated said tunnels.

On receipt of this acknowledgement message, the home location register HLR sends the AAA server SA, via the interface D′/Gr′ (arrow F32′ in FIG. 3) a message to report to it that the tunnels previously established between the mobile station MS and the SGSN node NS have indeed been eliminated.

On receipt of this message the AAA server SA updates its memory or database, and then sends the first tunnel termination gateway T1 that originated the transfer, via the interface Wm (arrow F33′ in FIG. 3), a new tunnel establishment procedure end acknowledgement message.

On receipt of this acknowledgement message the first tunnel termination gateway T1 sends the mobile station MS (which requested the transfer) an end of procedure report message, via the interface lu-PS (arrow F34′ in FIG. 3), in order to report to it that the new tunnel establishment procedure has terminated. This message is of the “E2E Tunnel Establishment Ack( )” type, for example.

On receipt of this message, the mobile station MS can then use the two new (VPN/IPSec) tunnels established between it and the tunnel termination gateways T1 and T2 (arrows F35′ and F37′ in FIG. 3) and the other two “new” (GTP) tunnels, previously modified by changing ends and respectively established between the tunnel termination gateways T1 and T2 and the GGSN nodes G1 and G2 (arrows F36′ and F38′ in FIG. 3).

Thanks to these new tunnels (arrows F35′ to F38′), continuity of service is therefore assured for the mobile station MS during the transfer of its communication sessions from the 3GPP mobile network to the WLAN network.

The processor module MT of the interface equipment ED can be produced in the form of electronic circuits, software (or electronic data processing) modules, or a combination of circuits and software.

The invention is particularly advantageous because it requires neither modification or adaptation of the SGSN nodes and the GGSN nodes already installed in the 3GPP core network, nor the creation of new protocols. Furthermore, the invention enables the use of the standard 3GPP interfaces.

The invention is not limited to the interface equipment ED and management method embodiments described hereinabove by way of example only, but encompasses all variants that the person skilled in the art might envisage within the scope of the following claims.

1. Method of managing interworking between a wireless local area network and a mobile network both connected to a core network comprising at least two GGSN nodes connected to respective service networks, at least one SSGN node connected to said mobile network and to said GGSN nodes, and at least two tunnel termination gateways connected to said wireless local area network and to said GGSN nodes, respectively, wherein, in the case of generation by a mobile station, having set up at least two communication sessions via tunnels established between said gateways, respectively said SGSN node, and said GGSN nodes, of a message reporting a transfer of said communication sessions from said wireless local area network, respectively said mobile network, to said mobile network, respectively said wireless local area network, said method consists in i) determining communication identifiers of said gateways, respectively a communication identifier of said SGSN node, ii) using an interface equipment, connected to said gateways and to said SGSN node to recover transfer SGSN contexts of said mobile station from said identified gateways, respectively from said identified SGSN node, and iii) at said GGSN nodes identified by said received transfer SGSN contexts, updating service PDP contexts intended to eliminate and/or modify said tunnels, and establishing new tunnels between said mobile station and said GGSN nodes via said SGSN node, respectively said gateways, to assure continuity of service during the transfer of the communication sessions.

2. Method according to claim 1, wherein in the case of transfer of said communication sessions from said wireless local area network to said mobile network, a) said mobile station sends said SGSN node a routing area update report so that it sends said interface equipment a message requesting the transfer SGSN contexts of said mobile station, and b) on receipt of said request message said interface equipment recovers from an AAA server of said mobile network said communication identifiers of said gateways involved in the sessions of the mobile station being transferred, so as to recover from said identified gateways said transfer SGSN contexts of said mobile stations.

3. Method according to claim 2, wherein in step iii) security operations are effected before updating said service PDP context.

4. Method according to claim 2, wherein in step iii) said SGSN node sends each of said GGSN nodes a service PDP context update request and then sends said home location register a message reporting that it is being substituted for said gateways, so that it instructs said AAA server to eliminate the tunnels established between said mobile station and said gateways.

5. Method according to claim 4, wherein said SGSN node generates said substitution report message on receipt of substitution confirmation messages coming from said GGSN nodes.

6. Method according to claim 2, wherein in step iii) on receipt of said substitution report message said home location register stores a communication identifier of said interface equipment.

7. Method according to claim 1, wherein in case of transfer of said communication sessions from said mobile network to said wireless local area network, a′) said mobile station sends a first of said gateways a first end-to-end tunnel establishment request containing a user identifier and a first access point name, b′) on receipt of said first request said first gateway sends said AAA server a tunnel establishment authorization request for said mobile station, containing said user identifier and first access point name, a request to obtain information for said establishing of the tunnel, and a request to obtain at least one communication identifier of said SGSN node involved in said session transfer, and c′) once in possession of said authorization and said information, said first tunnel termination gateway starts an EAP authentication and authorization procedure for said first access point name, with said mobile station and said AAA server, so as to pre-establish a tunnel between the mobile station and the first tunnel termination gateway.

8. Method according to claim 7, wherein once said EAP procedure has terminated, said first gateway sends said interface equipment a message requesting the transfer SGSN contexts of said mobile station and including said communication identifier of the SGSN node involved in said session transfer, and on receipt of said request message said interface equipment interrogates said home location register to determine the communication identifier of said SGSN node and then recovers from said identified SGSN node said transfer SGSN contexts of said mobile station, which are associated with the first access point name and with a second access point name, and then sends said first gateway a message containing the transfer SGSN context associated with said first access point name.

9. Method according to claim 7, wherein in step iii) said first gateway sends a first of said GGSN nodes a service PDP context update request and then sends said AAA server a first message reporting that it is being substituted for said SGSN node for the session associated with said first access point name.

10. Method according to claim 9, wherein said first gateway generates said first substitution report message on receipt of a substitution confirmation message coming from said first SGSN node.

11. Method according to claim 9, wherein in step iii) after said first substitution report message has been sent to said AAA server said interface equipment sends said second gateway a message containing said transfer SGSN context associated with said second access point name.

12. Method according to claim 11, wherein on receipt of said message said second gateway starts an EAP authentication and authorization procedure for said second access point name with said mobile station and said AAA server so as to pre-establish a tunnel between said mobile station and said second tunnel termination gateway.

13. Method according to claim 11, wherein in step iii), after receiving said message containing said transfer SGSN context associated with said second access point name, said second gateway sends a second of said GGSN nodes a service PDP context update request and then sends said AAA server a message reporting that it is being substituted for said SGSN node for the session associated with said second access point name.

14. Method according to claim 13, wherein said second gateway generates said second substitution report message on receipt of a substitution confirmation message coming from said second GGSN node.

15. Method according to claim 14, wherein on receipt of said second substitution report message said AAA server sends said home location register a message reporting that said gateways have been substituted for said SGSN node, in order for it to inform said SGSN node of that substitution, and on receipt of this substitution information said SGSN node eliminates said tunnels until then established between it and said mobile station and then sends said home location register an acknowledgement message informing it that it has eliminated said tunnels to said mobile station.

16. Method according to claim 15, wherein on receipt of said acknowledgement message said home location register sends said AAA server a message informing it that said tunnels to said mobile stations have been eliminated, on receipt of this elimination report message said AAA server sends said first gateway an end of new tunnel establishment procedure acknowledgement message, and on receipt of this acknowledgement message said first tunnel termination gateway sends said mobile station an end of procedure report message.

17. Method according to claim 1, wherein said communication identifiers are IP addresses and/or ISDN identifiers.

18. Network equipment for a core network comprising at least two GGSN nodes connected to respective service networks, at least one SGSN node connected to a mobile network and to said GGSN nodes, and at least two tunnel termination gateways connected to a wireless local area network and to said GGSN nodes, respectively, wherein it comprises processor means adapted, in case of reception of a message requesting transfer SGSN contexts of a mobile station seeking to transfer between said wireless local area network and said mobile network communication sessions set up via tunnels between said GGSN nodes and said gateways, respectively said SGSN node, to recover said transfer SGSN contexts of said mobile station from said gateways, respectively said SGSN node, in order to communicate them to said SGSN node, respectively to said gateways, so that it can be substituted for said gateways, respectively they can be substituted for said SGSN node, and establish new tunnels between it, respectively them, and said mobile station.

19. Network equipment according to claim 18, wherein said processor means are adapted, in case of transfer of said communication sessions from said wireless local area network to said mobile network and of reception from said SGSN node of a message requesting the transfer SGSN contexts of said mobile station, to recover from an AAA server of said mobile network said communication identifiers of said gateways involved in the sessions of the mobile station being transferred, and then to recover from said identified gateways said transfer SGSN contexts of said mobile station.

20. Network equipment according to claim 18, wherein said processor means are adapted, in case of transfer of said communication sessions from said mobile network to said wireless local area network and of reception from a first of said gateways of a message requesting the transfer SGSN contexts of said mobile stations, to send a request to said home location register so as to recover the communication identifier of the SGSN node involved in said session transfer, and then to recover from said identified SGSN node, by means of another request, said transfer SGSN contexts of said mobile station, which are associated with a first access point name and a second access point name, and then to send said first gateway a message containing the transfer SGSN context associated with said first access point name.

21. Network equipment according to claim 20, wherein said processor means are adapted, in case of substitution of said SGSN node by said first gateway, to send said second gateway a message containing said transfer SGSN context associated with said second access point name, said information and said communication identifier of the SGSN node.
